(19) United States
(12) Patent Application Publication
(10) Pub. No.: US 2008/0113566 A1
(43) Pub. Date: May 15, 2008

(54) Surface mount board-stacking connector

(76) Inventor: Janos Legrady, Putnam Valley, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/598,258

(22) Filed: Nov. 10, 2006

(51) Int. Cl. H01R 4/02

(52) U.S. Cl. 439/876; 439/875

(57) ABSTRACT

A board-stacking connector has surface-mounting connections to electrical contact pads or lands on two facing surfaces on two printed circuit boards that are spaced from each other a predetermined distance in two substantially parallel planes. The connector takes the form of a generally cylindrical shell of metallic material and defines an axis and a substantially uniform cross-sectional area along that axis. The shell has a wall closed on itself to define an internal cavity forming two openings, one at each of its axial ends, and this wall further defines generally flat contact surfaces normal to said axis and surrounds each of said respective openings. One of the contact surfaces is arranged to be in contact with a pad or land on one printed circuit board and the other of the contact surfaces is arranged to be in contact with a pad or land on the other spaced printed circuit board. The internal cavity is dimensioned so as to produce capillary action of molten solder on each of the pads or lands that are in contact with the contact surfaces, so that excess solder on the pads or lands is drawn into this cavity, at both axial openings, during reflow soldering.

### BACKGROUND OF THE INVENTION

1. Field of the Invention

This invention generally relates to surface mount connectors for printed circuit boards and, more specifically, to a surface mount connector for stacking or connecting two spaced printed circuit boards.

2. Description of the Prior Art

Numerous electrical contact designs have been proposed for mounting on printed circuit boards. Many of these are pins or posts that are formed by stamping flat sheet stock. In many cases, the pins or posts are initially connected to each other by a carrier strip to allow automated feeding and mounting on a printed circuit board. The aforementioned pins or posts take on different shapes, including relatively flat shapes as shown in U.S. Pat. No. 5,073,132. Thin flat posts are shown in U.S. Pat. No. 3,864,014. Box-type male connectors are illustrated in U.S. Pat. No. 3,375,486. Relatively large cross section pins are also disclosed in U.S. Pat. Nos. 4,017,142 and 3,428,934.

In U.S. Pat. Nos. 4,395,087 and 3,663,931, substantially square, solid pins are utilized as electrical contacts. In the '087 patent, the pins are mounted on a carrier strip while in the '931 patent a unitary pin is integral with a socket contact, formed of stamped material. In U.S. Pat. No. 4,369,572, a substantially solid rectangular pin is welded to the carrier strip. However, none of the known designs disclose pin connectors formed of flat sheet stock adapted or suitable for surface mounting on a printed circuit board.

It is also known to provide single loose surface mount pin terminals each packaged in individual plastic pockets P carried by a plastic pocket carrier or tape T, as shown in FIG. 18 and disclosed in U.S. Pat. No. 5,451,174. However, the aforementioned approach has a number of problems and has not found wide acceptance in the industry. To begin with, the additional plastic pockets or envelopes P have increased the per unit costs of the surface mounted components. Additionally, because the surface mounted pins are contained within a normally oversized pocket or enclosure, the components have at least some degree of freedom of movement therein and this has made it difficult and impractical to precisely align the components at the pick-up stations of the automatic pick-and-place equipment with the vacuum nozzles used for this purpose, notwithstanding the sprocket or pilot holes H intended to accurately align the pins. Such machinery demands very accurate alignment of the parts during pick-up and even small misalignments from the required positions may cause damage to the parts and/or to the nozzles themselves.

In view of the foregoing, although significant advancements have been made in the design and use of pick and place equipment, such machinery has primarily been used to pick and place components that have a sufficiently large flat surface to provide a suction area for engagement by the vacuum nozzles. As such, such machinery has primarily been used to pick and place transistors, ICs, capacitors, and numerous other electrical components that provide the requisite surfaces. However, because electrical posts, test points, IDC's and other electrical receptacles have not always exhibited the requisite geometries suitable for pick and place equipment, it has not always been possible to automate the mounting of such components utilizing surface mount technology.

Until now, therefore, surface mount posts were packaged in header form utilizing a plastic body to hold a row of components and placed on the board by a pick-and-place robot. If there was a need for test points, tabs, IDCs or any other type of single terminal, the board and the manufacturing process had to be a combination of surface mount technology and through-hole technology, because those terminals were only available for through-hole technology.

A two piece electrical contact pin is disclosed in U.S. Pat. No. 1,915,185. However, by its construction, the pin opening or aperture at one end thereof is capped to prevent solder molten on a pad or land of a printed circuit board from entering into the pin, were an effort made to surface mount the contact pin illustrated in the patent. Because the solder applied to the land would, upon melting, produce a fluid support the base of the pin would essentially “float” and move or shift on the pad or land. The only way that can be avoided is by providing capillary action so that the solder, once molten, is drawn away from the interface between the pin and the land and only a thin film of solder remains, as required, to secure the pin to the printed circuit board.

In U.S. Pat. No. 4,641,426, a surface mount connector system is illustrated which is compatible with surface mounting techniques because it can use reflow soldering instead of wave soldering. However, the plastic headers which are used require at least two holes which are shown as plated through holes. Therefore, the contacts that are disclosed are intended to be used with through the hole technology as opposed to surface mount technology. See, also, in this connection, U.S. Pat. No. 4,884,335.

In U.S. Pat. No. 5,451,174, a number of surface mount contact connectors in the form of pins are disclosed which are generally similar to the ones disclosed in U.S. patent application Ser. No. 08/121,206, assigned to the assignee of the present invention. However, the capillary action which is provided with these connectors is somewhat limited because solder is only drawn up into the small spaces defined within the base itself. When excess solder is provided on the printed circuit board, however, the designs illustrated in this patent and in the assignee's co-pending application may not be sufficient to draw sufficient solder away from the land and this may result in the contact “floating” on the surface of the printed circuit board with attendant movements away from predetermined or desired locations on the board.

In U.S. Pat. No. 5,816,868, assigned to Zierick Manufacturing Corporation, the assignee of the subject application, a capillary action promoting surface mount connector is disclosed in which one- and two-piece constructions are used for surface mounting to a surface of a printed circuit board at one end of the connector. In the one-piece construction, for example, an elongate channel is provided within a tubular pin that is flared at the lower end to form a base. The disclosed constructions include means for forming reservoirs, provided proximate to the base, which can receive excess solder during reflow operations. However, these contacts are designed as pins for use on printed circuit boards and not for interconnecting or stacking printed circuit boards that are spaced from each other.

### SUMMARY OF THE INVENTION

Accordingly, it is an object of the present invention to provide a surface mount connector for connecting or stacking spaced printed circuit boards, one that can be used to simply and inexpensively connect and stack printed circuit boards spaced from each other.

It is another object of the invention to provide a board stacking connector, as suggested, one that is simple in construction and economical to manufacture.

It is still another object of the invention to provide a board stacking connector, of the type under discussion, that has a very small footprint and can be used to interconnect two spaced printed circuit boards while utilizing very small contact areas on both boards.

It is yet another object of the present invention to provide a board-stacking connector, as suggested in the previous objects, that facilitates population of printed circuit boards at high densities.

It is a further object of the invention to provide a board-stacking connector as in the preceding objects that can provide Z-axis compliance to allow for thermal expansion without compromising or jeopardizing the solder connections to the spaced printed circuit boards.

It is still a further object of the present invention to provide board-stacking connectors that utilize surface mount technology (SMT) that are self-centering and virtually eliminate any alignment problems.

It is yet a further object of the present invention to provide a surface mount board-stacking connector that provides low contact resistance and high current ratings to satisfy most modular power requirements.

It is further an additional object of the invention to provide a board-stacking connector as in the previous objects that utilizes capillary action for stronger solder joints.

It is an additional object of the invention to provide a SMT board-stacking connector that can be used with existing placement machines and without the need of new insertion systems.

In order to achieve the above objects, as well as others that will become apparent hereinafter, a board-stacking connector for surface mounting connection to electrical contact pads or lands on two facing surfaces on two printed circuit boards spaced from each other a predetermined distance in two substantially parallel planes comprises a generally cylindrical shell formed of a metallic material that defines an axis in a substantially uniform cross-sectional area along the axis. The shell has a wall closed on itself to define an internal cavity or elongate channel forming two openings, one at each axial end of said shell. The wall further defines generally flat contact surfaces or edges normal to the axis and surrounds each of the respective openings. One of the contact surfaces is arranged to be in contact with a pad or land on a printed circuit board, and the other of the contact surfaces is arranged to be in contact with a pad or land on the other, spaced printed circuit board. The internal cavity is dimensioned to produce capillary action of molten solder on each of the pads or lands in contact with the contact surfaces. In this manner, excess solder on the pads or lands is drawn into the internal cavity during reflow soldering by capillary action at the openings at both axial ends.

According to one feature of the invention, the cylindrical shell forms a right circular cylinder defining circular cross-sections along its axial length. According to another feature of the invention, the shell is formed with compliance enhancing means for enhancing compliance, or axial expansion and contraction, of the shell along the axis. In this manner, the shell can change its axial length to comply with changes in spacing between the two printed circuit boards to which the shell is soldered without severing the connection(s) at either one of said flat contact surfaces. This provides the connector with Z-axis compliance to accommodate movements of the printed circuit board towards and away from each other due to thermal expansion or the like.

### BRIEF DESCRIPTION OF THE DRAWINGS

These and other objects and features of the present invention will become clear from the following description, taken in conjunction with preferred embodiments thereof with reference to the accompanying drawings, in which:

FIG. 1 is a perspective view of a surface mount board-stacking connector in accordance with the present invention;

FIG. 2 is a side elevational view of the connector shown in FIG. 1;

FIG. 3 is a top plan view of the connector shown in FIGS. 1 and 2;

FIG. 4 is a top plan view of a blank for forming the stacking connector shown in FIGS. 1-3;

FIG. 5 is a side elevational view showing the manner in which a board-stacking connector in accordance with the present invention is used to connect and stack two printed circuit boards arranged in spaced, substantially parallel planes;

FIG. 6 is a top plan view of a conductive pad or land illustrating a configuration that may be used on printed circuit boards for accommodating or connecting to the axial ends of the stacking connector in accordance with the present invention;

FIG. 7 is a side elevational view of another embodiment of a board-stacking connector in accordance with the present invention, incorporating a plurality of circular openings to enhance Z-axis compliance along the axial direction of the connector;

FIG. 8 is a top plan view of the stacking connector shown in FIG. 7;

FIG. 9 is a top plan view of a blank for making the stacking connector shown in FIGS. 7 and 8, illustrating the details of the arrangements of openings through the wall;

FIG. 10 is a side elevational view of still another embodiment of a stacking connector in accordance with the present invention, provided with elongate openings or slots in the wall of the connector to enhance Z-axis compliance, as aforementioned;

FIG. 11 is a top plan view of the connector shown in FIG. 10; and

FIG. 12 is a top plan view of a blank for making the stacking connector shown in FIGS. 7 and 8, provided with a series of spaced slots generally oriented in directions parallel to the axis of the connector.

### DESCRIPTION OF THE PREFERRED EMBODIMENTS

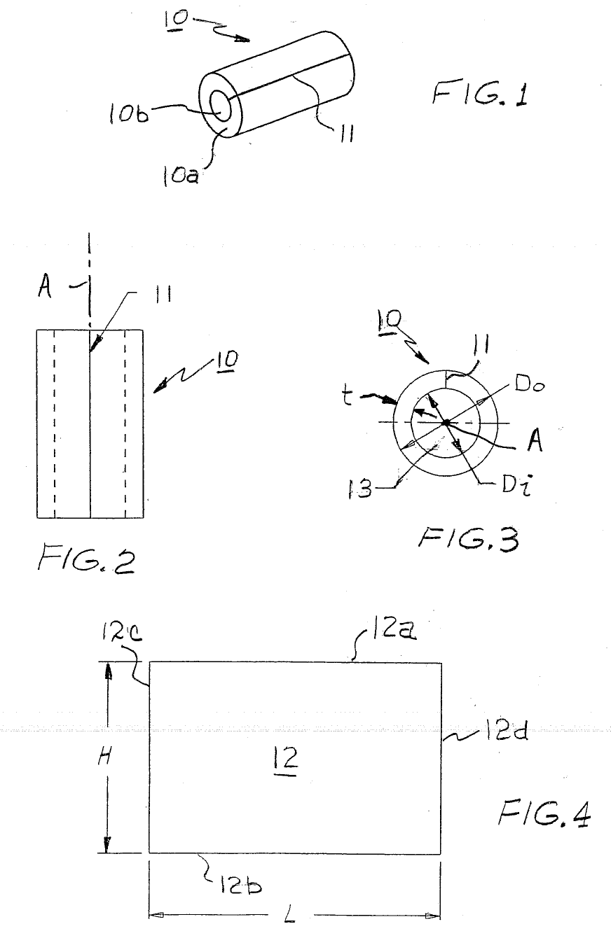

Referring now specifically to the drawings, in which identical or similar parts have been designated by the same reference numerals throughout, and first referring to FIGS. 1-3, a surface mount board-stacking connector in accordance with the present invention is generally designated by the reference numeral 10.

The connector 10 is used, as will be more fully described below, to provide surface mounting connections to electrical contact pads or lands on two facing surfaces on two printed circuit boards spaced from each other a predetermined distance and in substantially parallel planes. As shown, the connector 10 is generally in the form of a cylindrical shell or sleeve formed of a metallic material. While the specific material used is not critical for purposes of the present invention, the sleeve 10, in accordance with the preferred embodiment, is formed of brass. Also, the connector 10 is preferably provided with a metallic finish at least on those surfaces that make contact with the printed circuit board, as will become evident hereafter. Such finish is preferably in the form of a metallic coating. The specific coatings used are not critical for the present invention, although the connector 10 in the described embodiment is coated with a layer of tin over a layer of copper.

The connector 10 generally comprises a cylindrical shell, as shown, which defines an axis A and substantially uniform cross-sectional area along such axis. The shell is formed of a generally rectangular panel 12, as shown in FIG. 4, which defines upper edges 12a, 12b, and lateral or side edges 12c, 12d. In the finished connector shown in FIGS. 1-3 the blank or wall 12 is closed on itself to define a cylindrical contact that defines an internal cavity 13 and which forms two axial contact surfaces 10a and a generally elongate internal cavity or channel 13 that forms two openings 10b, one at each axial end of the shell. The wall 12 further defines the generally flat contact surfaces 10a that are generally normal to the axis A and surround each of the respective openings.

One of the contact surfaces 10a is arranged to be in contact with a pad or land on one printed circuit board, and the other of the contact surfaces is arranged to be in contact with a pad or land on the other spaced printed circuit board. The internal cavity is dimensioned to produce capillary action of molten solder on each of the pads or lands in contact with the contact surfaces. In this way, excess solders on the pads or lands is drawn the internal cavity during reflow soldering by capillary action at both axial openings.

It should be evident that the specific cross-sectional configuration of the shell of the connector 10 or of the channel or cavity and, therefore, the openings 10b, is not critical. However, the embodiment illustrated in FIGS. 1-3 forms a circular right cylinder defining circular cross-sections, as best evident from FIGS. 1 and 3.

When the blank 12 shown in FIG. 4 is formed to create the cylindrical shell or connector 10, the opposing edges 12c, 12d are brought into proximity and abut against each other and form a seam 11, best shown in FIGS. 2 and 3. The seam 11 is generally parallel to the axis A. While the edges 12c, 12d can be soldered or otherwise connected at the seam 11, this is not critical. Once the blank or wall 12 is formed into the shaped illustrated in FIGS. 2 and 3, there are no meaningful stresses acting on the connector that tend to separate the edges 12c, 12d once the connector or sleeve has been formed.

Referring to FIGS. 1 and 4, the wall 12, and specifically the upper and lower edges 12a, 12b form generally flat connect surfaces 10a generally normal to the axis A and surrounding each of the respective openings 10b, one of the contact surfaces being arranged to be in contact with a pad or land on one printed circuit board, while the other of the contact surfaces is arranged to be in contact with a pad or land on the other spaced, circuit board.

The internal cavity or channel 13 is dimensioned to produce capillary action of molten solder on each of the pads or lands in contact with a respective contact surface 10a.

It will be evident to those skilled in the art that numerous configurations of both the cylindrical shell and the internal channel or cavity will produce capillary action during reflow of solder provided on the pads or lands on the printed circuit boards. In the embodiment shown in FIGS. 1-3, the outer diameter Dₒ is approximately twice the inner diameter Dᵢ of the internal cavity. The thickness of the shell or wall is t, best shown in FIG. 3. The radial size of the shell will be a function of the length L of the top and bottom edges 10a, 12b. The height H of the blank 12 as well as the height of the formed contact or shell will be a function of the lengths of the edges 12c, 12d. Clearly, the height H will be selected to correspond to the spacing between the printed circuit boards that are to be stacked or connected to each other. Thus, referring to FIG. 5, two printed circuit boards 14, 16, spaced from each other a distance B, would require a stacking connector having a height H that is substantially equal to B, taking into account the thicknesses of the pads or lands, which are negligible.

In use, the board-stacking connector 10 is placed vertically on a land 22, shown in FIG. 6, provided on the lower printed circuit board 14, which serves as the motherboard. With solder paste applied to the land 22, the contact may be positioned on the land in any suitable manner, such as a suitable pick-and-place machine or a board-stacking connector feeder marketed by Zierick Manufacturing Corporation under the trademark “SURFSHOOTER SMT™”. Once the connector is positioned on the land on the lower printed circuit board, the board may be moved through a suitable reflow station in which the solder paste is heated and the solder melts, causing excess solder to be drawn into the internal cavity or channel 13 and creating a reliable solder joint 18. After this step, the upper printed circuit board 16, sometimes referred to as the “daughterboard,” is positioned so that the upper edge of the connector 10 abuts against or contacts a comparable land 22 provided on the undersurface of the printed circuit board 16. The stacked combination can now be suitably heated, and the solder reflowed to result in additional excess solder, this time at the upper surface, to be drawn into the internal cavity or channel by capillary action. It will be clear, therefore, that the connector 30 allows for the connection of a motherboard and a daughterboard to be joined to each other, and these boards become stacked on this connector without through-hole pins. While only a single connector 10 is shown, it will be appreciated that as many or as few connectors may be mounted on a motherboard 14 and correspondingly connected to the daughterboard.

Due to the generation of heat in electrical circuits, expansion and contraction attend these operations as a result of wide fluctuations in temperature. Another feature of the present invention is that the contact or shell can be formed with compliance-enhancing means for enhancing compliance of the shell along the axis A, along the vertical direction as viewed in FIG. 5. In this way, the shell can change its axial length to comply with changes in spacing between the two printed circuit boards to which the shell is soldered, without severing the connection, at either of said flat contact surfaces. According to a features of this invention, such compliance-enhancing means comprises at least one opening in the cylindrical wall forming the shell or contact. More typically, and preferably, a plurality of such openings are provided in the cylindrical wall to enhance such compliance feature. Referring to FIGS. 7-9, there are shown two sets or rows of circular openings, including upper circular openings 24 and lower circular openings 26. The circular openings 24, 26 are shown to be substantially equally spaced from each other along lines parallel to upper and lower edges of the blank 12′. Such holes are, therefore, also substantially equally angularly spaced from each other about the axis A. The rows along which the holes 24, 26 are arranged are substantially equally spaced from the upper and lower edges, as well as from each other, although the specific spacings of these rows along the height H of wall 12′ is not critical. The spacing of the openings 24, 26 from each other along the directions of the rows is likewise not critical, although preferably the openings in each of the rows are substantially equally angularly spaced from each other about the axis A.

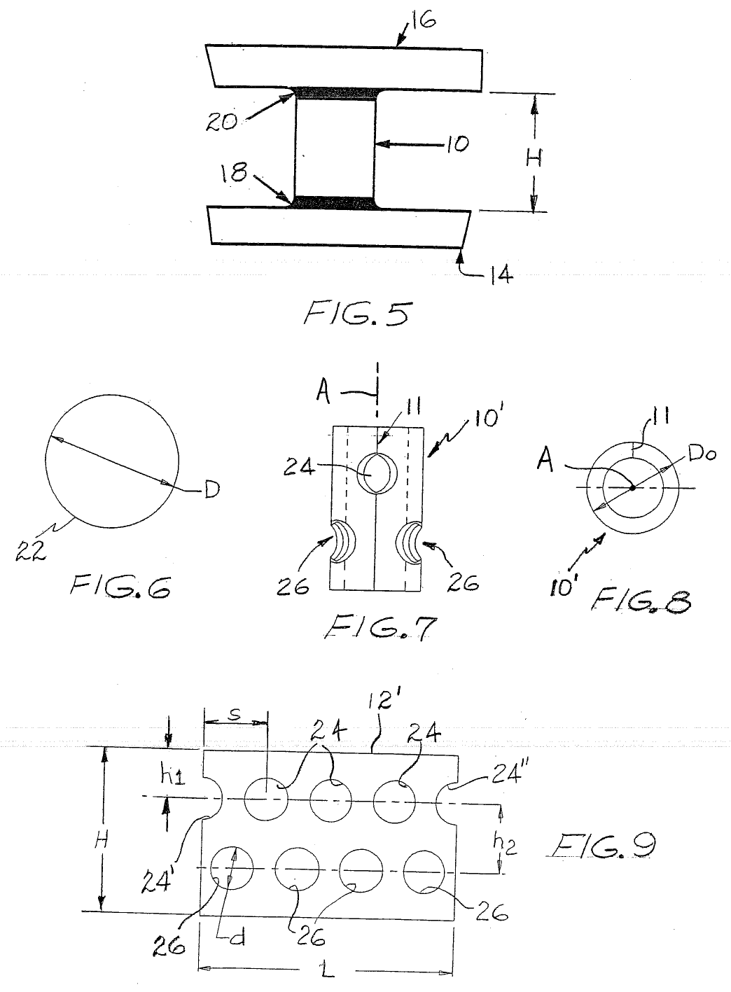

In FIGS. 7 and 9, the openings 24 in the upper row are angularly offset about the axis in relation to openings 26 in the lower row by one-half of the angular spacing between adjacent openings. This results in four complete openings 26 in the lower row, while the upper row includes three complete openings centered within the blank, the fourth opening being formed by semicircular openings 24′, 24″ formed along the lateral or side edges of the blank. When those edges are abutted, as shown in FIG. 7, the two semicircular openings combine to form one complete opening 24, as shown.

The specific shapes or configurations of the openings, while shown to be round in the embodiment at present preferred, are not critical, and any shapes or configurations of such openings can be used that will enhanced the axial compliance of the contact. Likewise, while the diameter d of the openings 24, 26 is typically 0.008 inches in this preferred embodiment, it will be clear that such diameters may be modified to suit any particular application. The preferred embodiment illustrated in FIGS. 7-9 also includes, by way of example, a height H=0.03 inches, h₁=0.009 inches, h₂=0.013 inches and L=0.048 inches. With such a blank, the outer diameter Dₒ is typically in the range of 0.017-0.022 inches. For a contact 10 having these dimensions, the land 22 could preferably have a diameter of 0.025 inches.

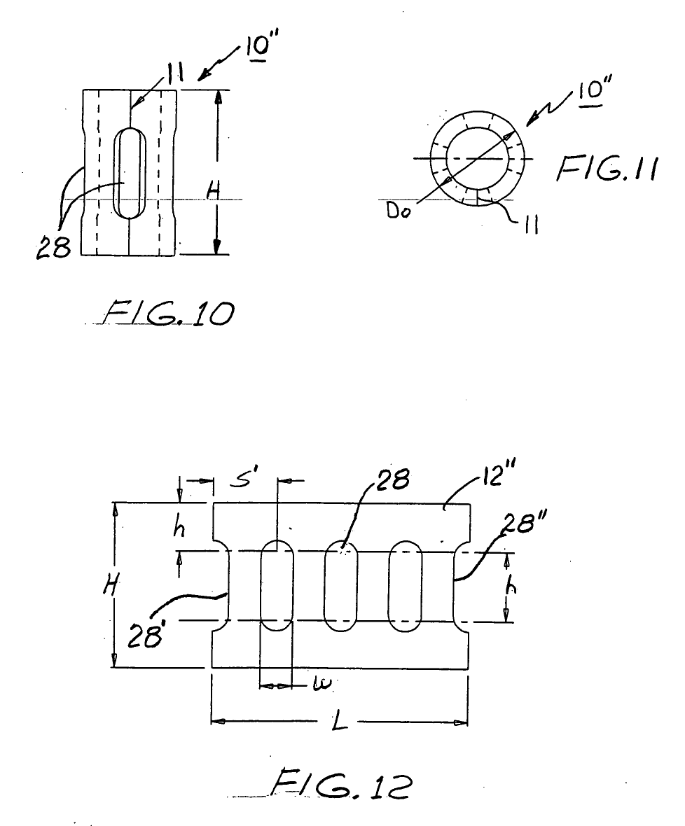

Referring to FIGS. 10-12, a surface mount board-stacking connector 10″ is shown, one that is in many respects similar to the connector 10′ shown in FIGS. 7-9. However, compliance in this connector 10″ is provided by at least one opening in the form of at least one slot in the wall, this slot being generally directed parallel to the axis A and having longitudinal ends spaced from the upper and lower edges or the associated contact surfaces. In the embodiment illustrated, a plurality of such slots are provided that are angularly substantially equally spaced from each other about the axis A. Here, the height H, similar to the height in FIG. 9, is 0.031. The slots have axial lengths h₃=0.013 inches and having arcuate semicircular upper and lower ends the radii of curvature of which are positioned at a distance h₄=0.009 inches from the upper and lower edges of the blank. The width of the slots w are typically 0.006 inches, while the remaining dimensions may be similar or comparable to those of the contact 10′. As with the circular openings 24 in FIG. 9, the slots in this embodiment are shown to be arranged such that the fourth slot is formed of semi-slots 28′ and 28″ formed in the lateral or side edges of the blank 12″.

It will be evident from the above discussion that the surface mount board-stacking connector in accordance with the present invention facilitates mounting to both the bottom and the top of a printed circuit, thus allowing for the connection of a motherboard and a daughterboard without through-hole pins. This results in greater PCB design flexibility, greater cost efficiency and a higher-quality connection.

The contacts can be easily made available in bulk, on palettes, or on SMT tape, and these connectors use minimal real estate and allow for additional components to be placed on the PCB.

An important feature of the invention is that such connectors are self-centering and offer co-planarity within 0.001 inches, virtually eliminating any alignment problems. Additionally, such contacts have low contact resistance and a high current rating to meet today's modular power requirements.

A central, key element of the board-stacking connectors is the use of the benefits of capillary action to provide superior solder joint strength and a more reliable connection. The connectors are first surface-mounted to the motherboard. After reflow, the PCB, with the connectors, are surface-mounted to the daughterboard.

While this invention has been described in detail with particular reference to preferred embodiments thereof, it will be understood that variations and modifications will be effected within the spirit and scope of the invention as described herein and as defined in the appended claims.

1. A board-stacking connector for surface mounting connections to electrical contact pads or lands on two facing surfaces on two printed circuit boards spaced from each other a predetermined distance in two substantially parallel planes, comprising a generally cylindrical shell formed of metallic material and defining an axis and a substantially uniform cross-sectional area along said axis, said shell having a wall closed on itself to define an internal cavity forming two openings, one at each axial end of said shell, said wall further defining generally flat contact surfaces normal to said axis and surrounding each of said respective openings, one of said contact surfaces being arranged to be in contact with a pad or land on one printed circuit board and the other of said contact surfaces being arranged to be in contact with a pad or land on the other spaced printed circuit board, said internal cavity being dimensioned to produce capillary action of molten solder on each of the pads or lands in contact with said contact surfaces, whereby excess solder on the pads or lands is drawn into said internal cavity during reflow soldering by capillary action at both axial openings.

2. A board-stacking connector for surface mounting connections as defined in claim 1, wherein a generally cylindrical shell forms a circular right cylinder defining circular cross-sections.

3. A board-stacking connector for surface mounting connections as defined in claim 2, wherein an outer diameter of said shell about said axis is approximately twice an inner diameter of said internal cavity.

4. A board-stacking connector for surface mounting connections as defined in claim 1, wherein said shell is formed of a substantially rectangular blank of metal.

5. A board-stacking connector for surface mounting connections as defined in claim 4, wherein said blank is formed into said cylindrical shell to create seam where said blank has butted edges generally parallel to said axis.

6. A board-stacking connector for surface mounting connections as defined in claim 1, wherein said metallic material comprises brass.

7. A board-stacking connector for surface mounting connections as defined in claim 1, wherein said metallic material is finished at least on said contact surfaces with a metallic coating.

8. A board-stacking connector for surface mounting connections as defined in claim 7, wherein said metallic coating comprises a layer of tin over a layer of copper.

9. A board-stacking connector for surface mounting connections as defined in claim 1, wherein said shell has a solid wall.

10. (canceled)

11. A board-stacking connector for surface mounting connections as defined in claim 21, wherein said compliance enhancing means comprises at least one opening in said cylindrical wall.

12. A board-stacking connector for surface mounting connections as defined in claim 11, wherein a plurality of openings are provided in said cylindrical wall.

13. (canceled)

14. A board-stacking connector for surface mounting connections as defined in claim 22, wherein said circular openings are substantially equally angularly spaced from each other about said axis.

15. A board-stacking connector for surface mounting connections as defined in claim 22, wherein two rows of circular openings are provided in said wall and axially spaced from each other and from said contact surfaces.

16. A board-stacking connector for surface mounting connections as defined in claim 15, wherein the same number of circular openings are provided in each row.

17. A board-stacking connector for surface mounting connections as defined in claim 16, wherein said openings in each row are substantially equally angularly spaced from each other about said axis.

18. A board-stacking connector for surface mounting connections as defined in claim 17, wherein said openings in one row are angularly offset about said axis in relation to said openings in said other row by one half the angular spacing between adjacent openings.

19. A board-stacking connector for surface mounting connections as defined in claim 11, wherein said at least one opening comprises at least one slot in said wall generally directed parallel to said axis and having longitudinal ends spaced from associated contact surfaces.

20. A board-stacking connector for surface mounting connections as defined in claim 19, wherein a plurality of said slots are provided angularly and substantially equally spaced from each other about said axis.

21. A board-stacking connector for surface mounting connections to electrical contact pads or lands on two facing surfaces on two printed circuit boards spaced from each other a predetermined distance in two substantially parallel planes, comprising a generally cylindrical shell formed of metallic material and defining an axis and a substantially uniform cross-sectional area along said axis, said shell having a wall closed on itself to define an internal cavity forming two openings, one at each axial end of said shell, said wall further defining generally flat contact surfaces normal to said axis and surrounding each of said respective openings, one of said contact surfaces being arranged to be in contact with a pad or land on one printed circuit board and the other of said contact surfaces being arranged to be in contact with a pad or land on the other spaced printed circuit board, said internal cavity being dimensioned to produce capillary action of molten solder on each of the pads or lands in contact with said contact surfaces, whereby excess solder on the pads or lands is drawn into said internal cavity during reflow soldering by capillary action at both axial openings, wherein said shell is formed with compliance enhancing means for enhancing compliance of said shell along said axis, whereby said shell can change its axial length to comply with changes in spacing between the two printed circuit boards to which said shell is soldered without severing the connection at either of said flat contact surfaces.

22. A board-stacking connector for surface mounting connections to electrical contact pads or lands on two facing surfaces on two printed circuit boards spaced from each other a predetermined distance in two substantially parallel planes, comprising a generally cylindrical shell formed of metallic material and defining an axis and a substantially uniform cross-sectional area along said axis, said shell having a wall closed on itself to define an internal cavity forming two openings, one at each axial end of said shell, said wall further defining generally flat contact surfaces normal to said axis and surrounding each of said respective openings, one of said contact surfaces being arranged to be in contact with a pad or land on one printed circuit board and the other of said contact surfaces being arranged to be in contact with a pad or land on the other spaced printed circuit board, said internal cavity being dimensioned to produce capillary action of molten solder on each of the pads or lands in contact with said contact surfaces, whereby excess solder on the pads or lands is drawn into said internal cavity during reflow soldering by capillary action at both axial openings, said shell being formed with compliance enhancing means for enhancing compliance of said shell along said axis, whereby said shell can change its axial length to comply with changes in spacing between the two printed circuit boards to which said shell is soldered without severing the connection at either of said flat contact surfaces, said compliance enhancing means comprising at least one opening in said cylindrical wall, a plurality of openings being provided in said cylindrical wall and at least one row of circular openings being provided in said wall.
